(19) United States
(12) Patent Application Publication
(10) Pub. No.: US 2009/0144334 A1
(43) Pub. Date: Jun. 4, 2009

(54) SYSTEM AND METHOD FOR CONTACT MANAGEMENT

(76) Inventor: Randolph Preston McAfee, San Marino, CA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 11/950,250

(22) Filed: Dec. 4, 2007

(51) Int. Cl. G06F 17/30

(52) U.S. Cl. 707/200; 707/E17.005

(57) ABSTRACT

An automated system and method for periodically searching information relating to a person's contact list and updating an informational database. A target name is extracted from a contact list of a user, and a search is performed (e.g. on the Internet) for data related to the target name. The data is analyzed in accordance with categories of information in the contact list. A determination is made whether a corresponding item in the contact list requires modification. The data is stored on a database, indexed with the target name. The method is performed periodically and automatically. Analysis of the data may include determining whether the data is relevant to a category of information on a predefined alert list. An alert message may be displayed to the user regarding an item of data, if that data is determined to be relevant to a category of information on the alert list.

### FIELD OF THE DISCLOSURE

This disclosure relates to an automated system and method for maintaining a list of personal contacts.

### BACKGROUND OF THE DISCLOSURE

Many people, especially in professional life, have extensive lists of contacts (that is, people with whom they maintain contact approximately once per year). Information on a person's contact list is always subject to going out of date, as various changes (e.g. address, employment, etc.) occur in the lives of those on the list. A person may use a manual search on the world wide web in order to keep up with changes in his contacts' lives. However, this can be a very time-consuming process and often results in inaccuracies.

### SUMMARY OF THE DISCLOSURE

The present disclosure provides an automated system and method for periodically searching information relating to a person's contact list and updating an informational database.

In accordance with a first aspect of the disclosure, a method is provided which includes extracting a target name from a contact list of a user; searching for data related to the target name; and analyzing the data in accordance with categories of information in the contact list. A determination is then made whether a corresponding item in the contact list requires modification. The data is stored on a database, indexed with the target name. The method is performed periodically and automatically. The analysis of the data may include determining whether the data is relevant to a category of information on a predefined alert list. An alert message may be displayed to the user regarding an item of data, if that data is determined to be relevant to a category of information on the alert list.

In accordance with another aspect of the disclosure, a system includes a contact management engine configured to perform the method described above.

In accordance with a further aspect of the disclosure, a computer-readable medium is provided having computer-readable instructions for managing a contact list tangibly stored thereon; the computer-readable instructions, when executed by a computer, perform the method described above.

Additional features of the disclosure will be described hereinafter that form the subject of the claims of the disclosure. Those skilled in the art should appreciate that they can readily use the disclosed embodiments as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic diagram of a system for managing a contact list, in accordance with an embodiment of the disclosure.

FIG. 2 illustrates steps in a method for searching, analyzing and updating contact information, in accordance with an embodiment of the disclosure.

FIG. 3 illustrates an example of search results from the method of FIG. 2.

FIG. 4 illustrates one type of search result obtainable using a system and method in accordance with an embodiment of the disclosure.

FIG. 5 illustrates another type of search result obtainable using a system and method in accordance with an embodiment of the disclosure.

FIG. 6 illustrates still another type of search result obtainable using a system and method in accordance with an embodiment of the disclosure.

### DETAILED DESCRIPTION

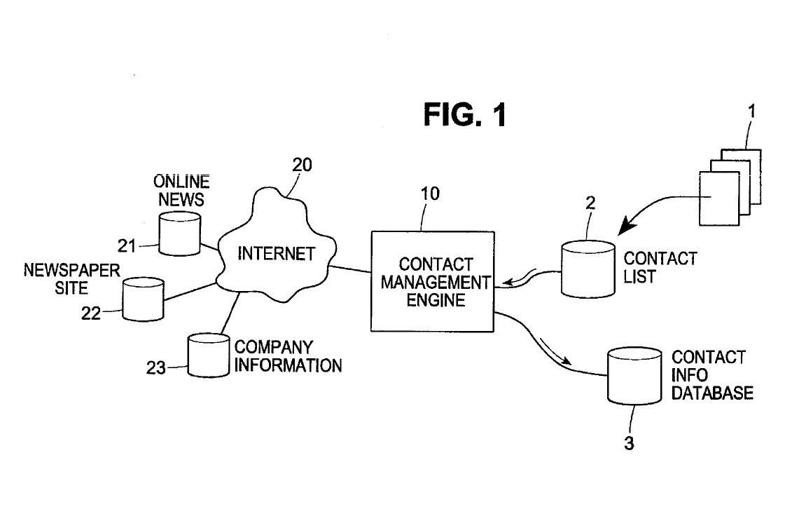

A system including a contact management engine in accordance with the present disclosure is shown schematically in FIG. 1. A user converts a conventional list of contacts 1 (paper lists, business cards, etc.) into machine-readable form; this list is then stored in a memory device 2. Memory device 2 is included in, or accessible by, a computing device of the user (personal computer, PDA, or the like). A contact management engine 10 accesses memory device 2 and extracts the name of a contact therefrom, and then proceeds to search via a network 20 (such as the Internet) for news articles and other information relating to that contact. As shown schematically in FIG. 1, this information typically resides on a variety of databases 21-23. The contact management engine 10 then retrieves, sorts, and analyzes the information, and stores updated contact information in a contact information database 3. In an embodiment, database 3 is separate from the stored contact list, and the updated information being stored in database 3 by engine 10 is also displayed to the user; the user then reviews the displayed information and makes changes to the contact list at his discretion. In another embodiment, engine 10 causes the contact list to be updated automatically in accordance using the analyzed search results. Security features (e.g. password protection) may be advantageously added to the contact list and/or the information database 3.

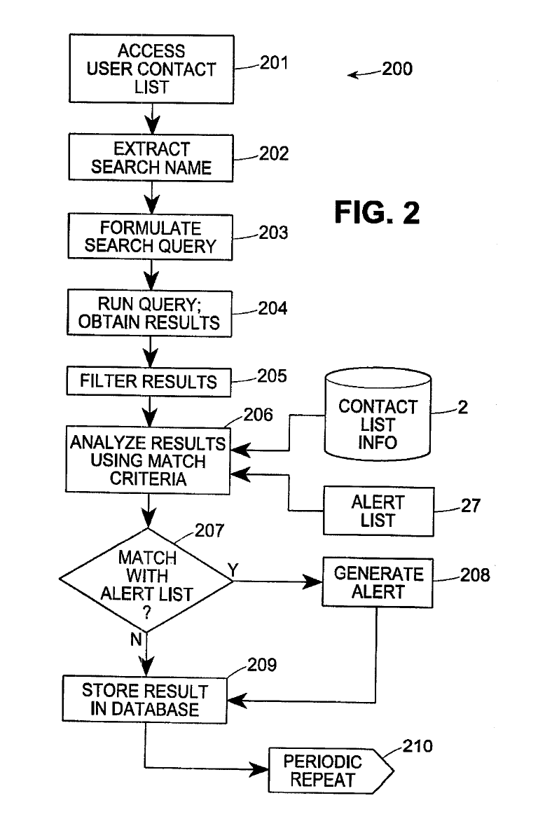

A process 200 by which contact management engine 10 searches, retrieves, and analyzes contact information is shown schematically in FIG. 2. The contact management engine accesses a user contact list (for example, a list of contacts in Microsoft Outlook®), and extracts a search name from that list (steps 201, 202). In step 203, the engine 10 formulates a search query based on criteria supplied by the user. For example, the search may be conducted by looking for an individual's name in a particular company or in a particular city. In step 204, the engine accesses the network 20 and queries various databases to find news or biographical information relating to the contact name. The query may be directed to an online news service 21, a newspaper's online website 22, or a database 23 maintained by a company having biographies of its employees.

The engine 10 then collects the results of a query and filters them (step 205). The query results may be filtered in accordance with a set of rules regarding a name of a person, a city, or a company. Filtering the query results is particularly important if the name of the contact is a relatively common name, which generally yields a large number of irrelevant results. In an embodiment, this is done by assigning a “likelihood” score to each search result; a match between the individual's name and his last known city, employer, etc. causes a predetermined increase in the likelihood score. Search results with a likelihood score below a certain threshold are then discarded.

After the search results are filtered, the engine analyzes the search results (step 206) by looking for matches between the search results and information that is already on the contact list, to determine what information needs to be updated. The types of information to be analyzed will depend on categories of information already present in the contact list. For example, the contact list will typically have an employment location for every contact, and the engine 10 will accordingly examine each search result for new information regarding the contact's work address. If the contact list also has a category “Publications by this contact” or the like, the engine 10 will then examine each search result for new information regarding articles, books, etc. published by the contact.

The user may set up an alert list 27 with items that trigger an alert directed to the user if a particular type of search result is found. For example, the alert list could have an item directing the engine 10 to generate an alert to the user if a news article is found relating to a change in the contact's employment status. Accordingly, if the search results have a match with an item in the alert list (step 207), then an alert will be generated (step 208) to bring that news article to the attention of the user.

The engine 10 stores the results of the search in the informational database 3, indexed with the contact's name (step 209), and optionally updates the contact list without any intervention by the user. If the engine does not update the contact list automatically, the engine may cause a reminder to be displayed, informing the user that she should review the new results added to database 3 and update the contact list accordingly.

The search results may be advantageously stored in the database 3 as a formatted text result. These results may also include links to the original news articles found by the engine 10.

The process 200 is repeated periodically (step 210), preferably monthly but not more often than every two weeks. It should be noted that the process 200 is performed without being initiated by the user, and generally is not visible to the user unless an alert is displayed or a reminder of the update is desired.

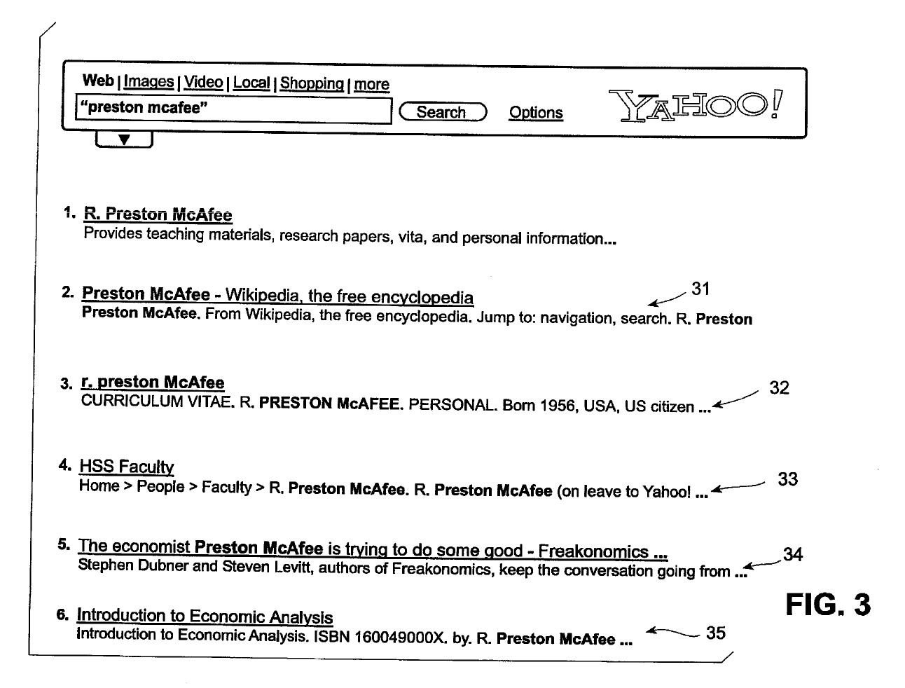

Besides storing the search results in the database 3, the engine 10 may also prepare the results in a list to be displayed, such as shown in FIG. 3. As may be seen in FIG. 3, the search results may include news articles and other items of information from a variety of online sources. For example, the list in FIG. 3 has an article in an online encyclopedia 31, the contact individual's resume 32, an academic biography 33, an online news article 34, and a description of a work 35 authored by the contact individual.

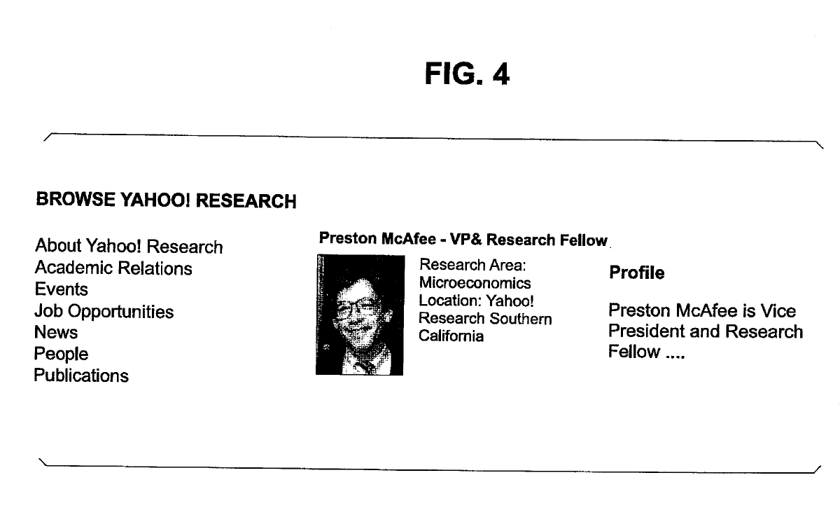

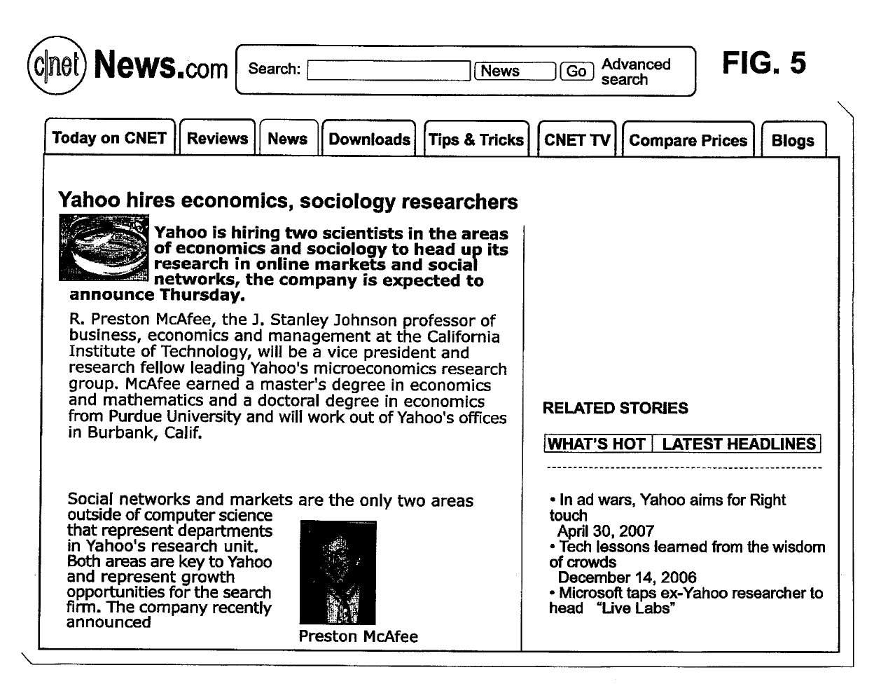

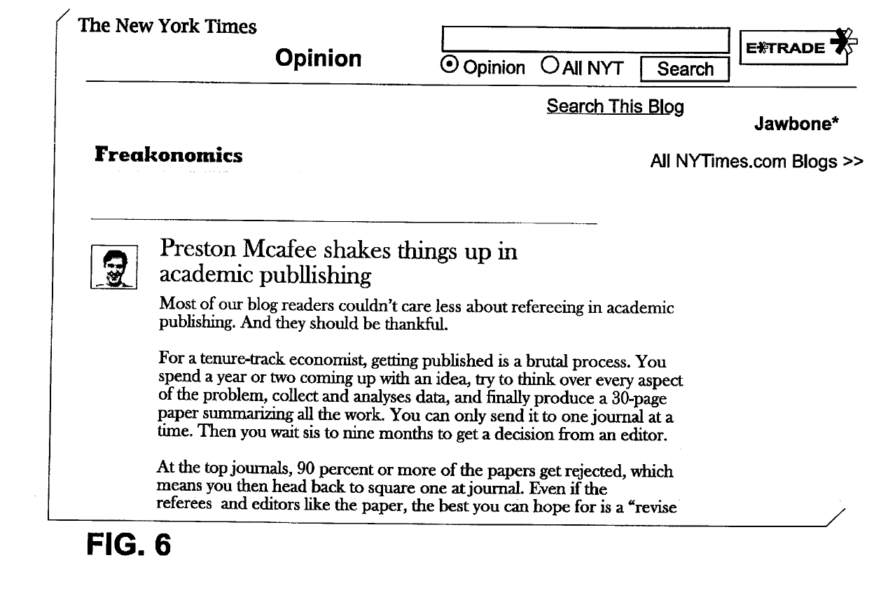

FIG. 4 shows an example of a search result from a database 23 maintained by the contact individual's employer and accessible via the Internet. The engine 10 may analyze the text in this search result to determine the contact's current employer, job title and employment location. The engine 10 may further analyze the text for information on the contact's recent professional activities, if such a category has been established in the contact list. FIG. 5 is an example of an article from an online news service 21, giving details of the contact individual's recent activities. FIG. 6 shows another example of a news article (from a newspaper web site 22) relating to a contact individual, with additional background information about the individual.

An “engine” as referred to herein is meant to describe a software, hardware or firmware (or combinations thereof) system, process or functionality that performs or facilitates the processes, features and/or functions described herein (with or without human interaction or augmentation). It will be appreciated that the contact management engine 10 may be resident on the computing device of the user, or may be resident on a server accessible by the user. For the purposes of this disclosure a server is software, hardware, or firmware (or combinations thereof) capable of performing the receiving, processing and serving steps in the above-described method. A server may be a single server or a group of servers acting together. The server may or may not be embodied as one system or as multiple parts of a distributed system, or as sub-systems of one or the other engines or systems described herein. A number of program modules and data files may be stored on a computer readable medium of the server They may include an operating system suitable for controlling the operation of a networked server computer, such as the WINDOWS XP or WINDOWS 2000 operating systems from MICROSOFT CORPORATION.

For the purposes of this disclosure a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In an embodiment the network 20 may be an intranet (a private version of the Internet). An intranet is a computer network allowing data transfer between computing devices on the network. Such a network may comprise personal computers, mainframes, servers, network-enabled hard drives, and any other computing device capable of connecting to other computing devices via an intranet. An intranet uses the same Internet protocol suit as the Internet. Two of the most important elements in the suit are the transmission control protocol (TCP) and the Internet protocol (IP).

For the purposes of this disclosure a computing device, including a computing device of the user maintaining his contact list, includes a processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. For example, the search results and/or alerts described herein may be formatted and/or displayed in a variety of ways to convey the desired information.

Numerous other changes may be made that will readily suggest themselves to those skilled in the art and which are encompassed in the spirit of the invention disclosed and as defined in the appended claims.

I claim:

1. A method comprising:
extracting a target name from a contact list of a user;
searching for data related to the target name;
analyzing the data in accordance with categories of information in the contact list, thereby determining whether a corresponding item in the contact list requires modification; and
storing the data on a database, indexed with the target name,
wherein the method is performed periodically and automatically.

2. A method according to claim 1, further comprising:
displaying the data to the user on demand.

3. A method according to claim 1, wherein said analyzing further comprises determining whether the data is relevant to a category of information on a predefined alert list.

4. A method according to claim 3, further comprising displaying an alert message to the user regarding said data, if said data is determined to be relevant to a category of information on the alert list.

5. A method according to claim 1, further comprising:
prior to said analyzing, filtering the data in accordance with a likelihood score, the likelihood score assigned to a given data item in accordance with a likelihood that the data is associated with an individual listed on said contact list.

6. A method according to claim 5, wherein the likelihood score is increased by a predefined amount according to whether a residence location, an employer name, and/or an employment location in said data item match the corresponding information in the contact list.

7. A method according to claim 1, further comprising displaying a message prompting the user to update the contact list in accordance with the stored data.

8. A method according to claim 1, further comprising updating the contact list in accordance with the analyzed data.

9. A method according to claim 8, further comprising displaying to the user a message that said updating has been performed.

10. A system comprising
a contact management engine configured to
extract a target name from a contact list of a user;
search for data related to the target name;
analyze the data in accordance with categories of information in the contact list, to determine whether a corresponding item in the contact list requires modification; and
store the data on a database, indexed with the target name.

11. A system according to claim 10, further comprising a display device, and wherein said engine is configured to display the data to the user on demand.

12. A system according to claim 10, wherein said engine is configured to determine whether the data is relevant to a category of information on a predefined alert list.

13. A system according to claim 12, wherein said engine is configured to display an alert message to the user regarding said data, if said data is determined to be relevant to a category of information on the alert list.

14. A system according to claim 10, wherein said engine is configured to assign a likelihood score to a given data item in accordance with a likelihood that the data is associated with an individual listed on said contact list, and filter the data in accordance with the likelihood score.

15. A system according to claim 14, wherein the likelihood score is increased by a predefined amount according to whether a residence location, an employer name, and/or an employment location in said data item match the corresponding information in the contact list.

16. A system according to claim 11, wherein the engine is configured to display a message prompting the user to update the contact list in accordance with the stored data.

17. A system according to claim 10, wherein the engine is configured to update the contact list in accordance with the analyzed data.

18. A system according to claim 17, wherein the engine is configured to display to the user a message that said update has been performed.

19. A computer-readable medium having computer-readable instructions for managing a contact list tangibly stored thereon, the computer-readable instructions, when executed by a computer, performing a method comprising:
extracting a target name from a contact list of a user;
searching for data related to the target name;
analyzing the data in accordance with categories of information in the contact list, thereby determining whether a corresponding item in the contact list requires modification; and
storing the data on a database, indexed with the target name,
wherein the method is performed periodically and automatically.

20. A computer-readable medium according to claim 19, wherein said analyzing further comprises determining whether the data is relevant to a category of information on a predefined alert list.

21. A computer-readable medium according to claim 19, wherein said method further comprises:
prior to said analyzing, filtering the data in accordance with a likelihood score, the likelihood score assigned to a given data item in accordance with a likelihood that the data is associated with an individual listed on said contact list.

22. A computer-readable medium according to claim 21, wherein the likelihood score is increased by a predefined amount according to whether a residence location, an employer name, and/or an employment location in said data item match the corresponding information in the contact list.

23. A computer-readable medium according to claim 19, wherein said method further comprises displaying a message prompting the user to update the contact list in accordance with the stored data.

24. A computer-readable medium according to claim 19, wherein said method further comprises updating the contact list in accordance with the analyzed data.

25. A computer-readable medium according to claim 24, wherein said method further comprises displaying to the user a message that said updating has been performed.
